(19) United States
(12) Patent Application Publication
(10) Pub. No.: US 2010/0007897 A1
(43) Pub. Date: Jan. 14, 2010

(54) DOCUMENT PROCESSING METHOD AND APPARATUS

(75) Inventor: Young-Ju Kim, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/417,061

(22) Filed: Apr. 2, 2009

(30) Foreign Application Priority Data
Jul. 10, 2008 (KR) 2008-67213

(51) Int. Cl. G06K 15/02; G06F 3/048; G06F 3/12; H04N 1/405; G06K 15/00

(52) U.S. Cl. 358/1.2; 715/764; 358/1.13; 358/3.06; 358/1.15; 358/1.16

(57) ABSTRACT

A document processing apparatus and method, the method including: selecting a document to be printed; displaying a user interface; setting at least one a number of vertical lines per inch value and a brush pattern expansion value, via the displayed user interface; and converting the document into printing data, according to the set value.

### CROSS-REFERENCE TO RELATED APPLICATION

This application claims the benefit of Korean Patent Application No. 2008-67213, filed on Jul. 10, 2008, in the Korean Intellectual Property Office, the disclosure of which is incorporated herein by reference.

### BACKGROUND OF THE INVENTION

1. Field of the Invention

Aspects of the present general inventive concept relate to a document processing method and apparatus.

2. Description of the Related Art

In multi-pass, single pass, or tandem printing electrophotographic processes, printing resolutions are being continuously increased. However, in order to support a high resolution, printing quality should be increased, which is expensive.

When printing data is prepared as a presentation, by using an application program, many colors exist in the background of the printing data. As such, rendering at a suitable resolution is performed, according to the pattern of the background, so as to increase the printing quality. However, printing data is conventionally rendered using a fixed number of vertical lines per inch and a fixed pattern brush, before being output. Thus, different colors are printed in each page of the printing data, and the quality of the background deteriorates, even when identical colors are printed.

### SUMMARY OF THE INVENTION

Aspects of the present general inventive concept provide a document processing method that prevents a reduction of the quality of the background of the document, when the document is converted to printing data and displayed as a presentation.

According to an aspect of the present general inventive concept, there is provided a document processing method including: selecting a document to be printed; displaying a user interface; setting at least one of a number of vertical lines per inch value of the document and a pattern expansion value of the document, via the displayed user interface; and converting the document into printing data, by applying the set value.

According to another aspect of the present general inventive concept, there is provided a computer readable recording medium having recorded thereon a program for executing the method.

According to another aspect of the present general inventive concept, there is provided a document processing apparatus that hosts an image forming apparatus. The document processing apparatus includes: a display unit that displays a user interface to set at least one of a number of vertical lines per inch value for a document, and a pattern expansion value of the document; and a data processing unit that converts the document into printing data, by applying values set via the user interface.

Additional aspects and/or advantages of the present general inventive concept will be set forth in part in the description which follows and, in part, will be obvious from the description, or may be learned by practice of the present general inventive concept.

### BRIEF DESCRIPTION OF THE DRAWINGS

These and/or other aspects and advantages of the present general inventive concept will become apparent and more readily appreciated from the following description of the exemplary embodiments, taken in conjunction with the accompanying drawings, of which:

FIG. 1 is a flowchart illustrating a document processing method, according to an exemplary embodiment of the present general inventive concept;

FIG. 2 is a diagram illustrating a user interface displaying options for setting at least one of a number of vertical lines per inch value and a pattern expansion value, according to an exemplary embodiment of the present general inventive concept;

FIG. 3A is a diagram illustrating a user interface produced when the option to set a number of vertical lines per inch is selected from the user interface of FIG. 2, according to an exemplary embodiment of the present general inventive concept;

FIG. 3B is a diagram illustrating a user interface produced when the option to set a pattern expansion value is selected from the user interface of FIG. 2, according to an exemplary embodiment of the present general inventive concept;

FIG. 4 is a block diagram illustrating a document processing system, according to an exemplary embodiment of the present general inventive concept; and

FIG. 5 is a block diagram illustrating a document processing apparatus, according to another exemplary embodiment of the present general inventive concept.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below, in order to explain the aspects of the present general inventive concept, by referring to the figures.

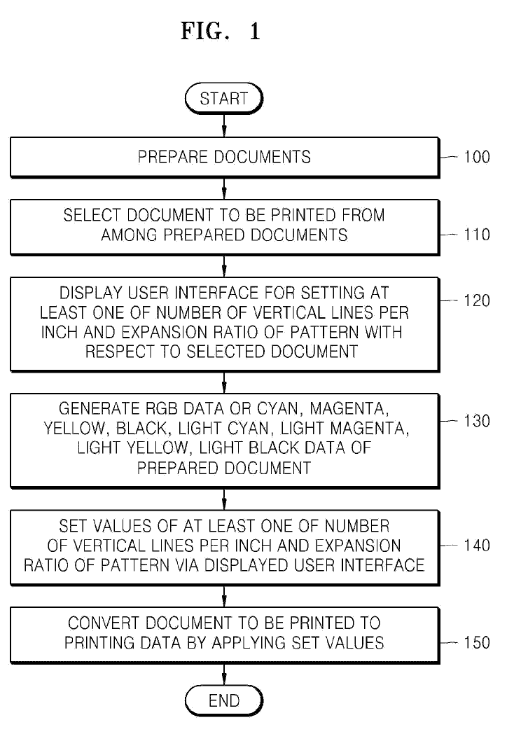

FIG. 1 is a flowchart illustrating a document processing method, according to an exemplary embodiment of the present general inventive concept. In operation 100, documents are prepared. An application program, which is stored in a host, can be used to prepare the documents. In this regard, the documents generally include colored images, such as photos, graphics, or text, in the backgrounds thereof. Here, the application program can be, for example, PowerPoint, Word, Excel, or the like.

In operation 110, a document is selected from among the documents prepared in operation 100. In operation 120, a user interface is displayed that includes options for setting at least one of a number of vertical lines per inch value, and a pattern expansion value, when the selected document is displayed. The number of vertical lines per inch value denotes a number of lines per inch, which form an image, i.e., the resolution of the image. Accordingly, when the number of vertical lines per inch of an image is increased, the resolution/quality of the image is increased. The pattern expansion value denotes a ratio at which the size of a pattern brush in the background of a document is changed. A pattern brush is a sequence of tiled objects, which extends along a path. Each object can be applied to a different segment of the path, depending on the characteristics of the path. Accordingly, when an expansion ratio of a pattern brush increases, the pattern brush is enlarged prior to printing, and thus, the resolution/quality of the associated pattern is increased.

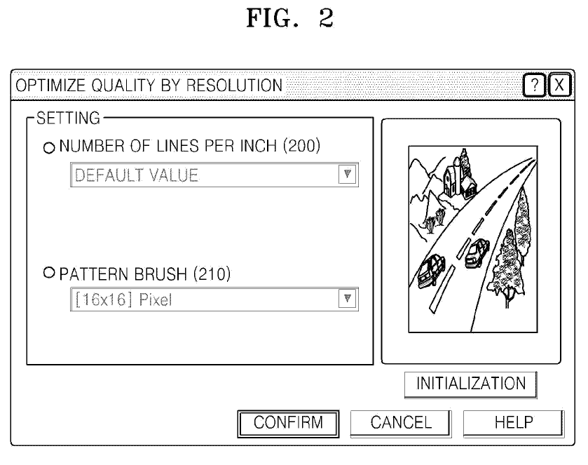

FIG. 2 is a diagram illustrating a user interface to select options for modifying a document, according to an exemplary embodiment of the present general inventive concept. The user interface of FIG. 2 includes an option 200 to select a number of lines per inch value, and an option 210 to select a pattern expansion value (in pixels). The number of vertical lines per inch value and/or the pattern expansion value may be set through the user interface of FIG. 2, according to some aspects, or may be set through associated interfaces.

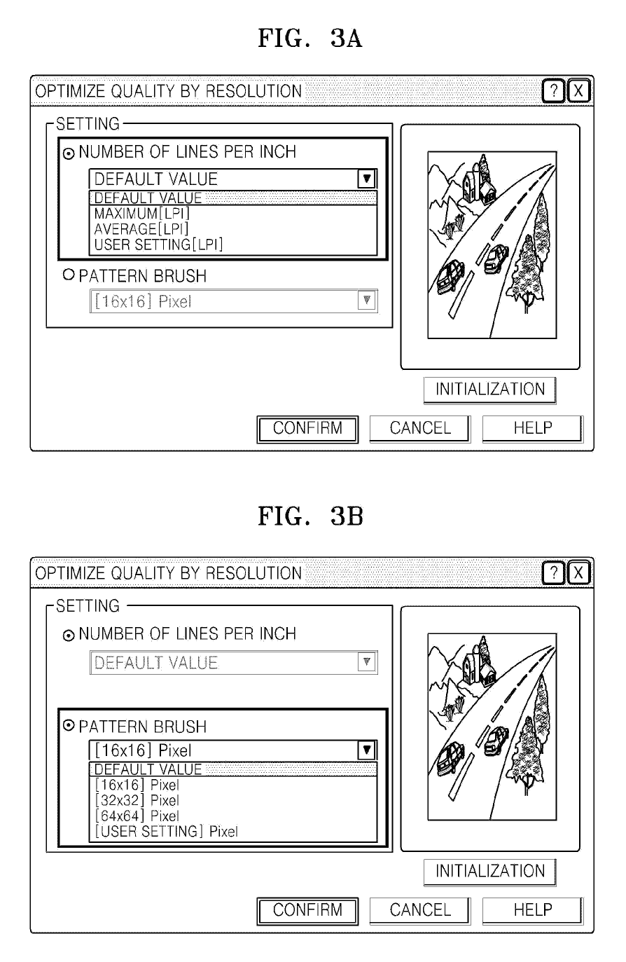

FIG. 3A is a diagram illustrating a user interface displayed when the option 200 is selected, through the user interface of FIG. 2. FIG. 3B is a diagram illustrating a user interface displayed when the option 210 is selected, through the user interface of FIG. 2. Herein, the user interfaces of FIGS. 2-3B can also be referred to as a single interface.

When the option 200 is selected from the user interface of FIG. 2, the user interface illustrated in FIG. 3A is displayed. A number of vertical lines per inch value may be set in the user interface of FIG. 3A. Accordingly, the resolution of an image may be optimized, according to the set a number of vertical lines per square inch value. The number of vertical lines per inch value may be selected from preset values, such as a default value, a maximum value, and an average value, or a user can input another value into a user input field (user setting) of the user interface of FIG. 3A. Here, the preset values are set according to a preexisting resolution of an image. For example, when the default value is 100 LPI, the average value may be 200 DPI, and the maximum value may be 400 DPI. The user input field can be used to input any desired value, such as 200 LPI or 250 LPI, for example.

When the option 210 is selected from the user interface of FIG. 2, the user interface illustrated in FIG. 3B is displayed. The user interface of FIG. 3B can include selectable preset pattern expansion values, such as a default value, a [16*16] pixel value, a [32*32] pixel value, or a [64*64] pixel value. The user interface of FIG. 3B, can include a user input field (user setting) to input any desired pattern expansion value, such as a [64*64] pixel value or a [128*128] pixel value. Here, a pattern expansion value corresponds to an expansion ratio that is used to adjust the size of a pattern brush of a document. Accordingly, when the pattern expansion value increases, the size of the pattern brush increases, and thus, the resolution/quality of the pattern brush increases.

Referring back to FIG. 1, color data, such as RGB, cyan, magenta, yellow, black, light cyan, light magenta, light yellow, and grayscale data of the document, is generated in operation 130, from the selected document. When the application program is used to prepare a document including images in the background thereof, such as photos, graphics, texts, pattern brushes etc., in operation 100, a driver of an image forming apparatus generates the color data, according to the characteristics of the images.

In operation 140, the number of vertical lines per inch and/or the expansion ratio of the pattern are set, via the corresponding user interfaces, as described above. The user interfaces of FIGS. 2-3B can be driven by driver of the image forming apparatus or a display panel of the image forming apparatus. The user interfaces of FIG. 2-3B can also be driven and/or displayed by a host of the image forming apparatus. Here, the display panel can be a touch screen, or a general display screen and keys that can be used by a user to input data.

According to an exemplary embodiment of the present general inventive concept, the driver of the image forming apparatus controls the user interface of FIG. 2, and thus, the number of lines per inch value and/or the pattern expansion value can be set, before converting a document to printing data, but the present teachings are not limited thereto. In other words, when the image forming apparatus controls the user interface of FIG. 2, the number of lines per inch value and/or the pattern expansion value may be set, after the document is generated by the host.

In operation 150, the document is converted to printing data (data in a printable/displayable format), by applying values set via the user interface, to the document. In other words, the color data of the document is converted into printable/displayable format, according to the set values.

In detail, when the number of vertical lines per inch value is set, via the user interface of FIG. 3A, the document is converted according to half-tones, by applying the set number of vertical lines per inch value thereto. In other words, the document is converted to printing data, by using a half-tone screen table, to which the set number of vertical lines per inch value is applied.

When the pattern expansion value is set, via the user interface of FIG. 3A, the document is converted into printing data, by adjusting an expansion ratio of a brush pattern thereof, according to the pattern expansion value. Generally, when a document is prepared using an application program, various pattern brushes are formed therein. The printing data includes modifications to such pattern brushes, which are made according to the set pattern expansion value. Accordingly, when a size of a pattern brush is increased, according to a pattern expansion value, the number of pixels forming the pattern brush is also increased accordingly. Thus, the quality of the pattern brush is also increased. The printing data rendered via operation 150 can be output to an image forming apparatus, which can display and/or print the printing data.

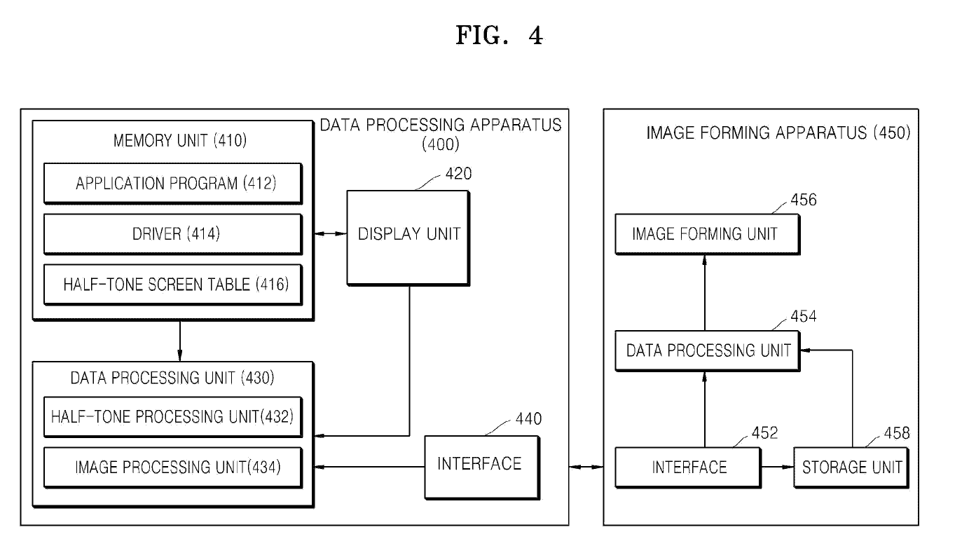

FIG. 4 is a block diagram illustrating a document processing system including a document processing apparatus 400 and an image forming apparatus 450, according to an exemplary embodiment of the present general inventive concept. Referring to FIG. 4, the document processing apparatus 400 includes a memory unit 410, a display unit 420, a data processing unit 430, and an interface 440.

The memory unit 410 includes an application program 412, a driver 414, and a half-tone screen table 416. The application program 412 is used to prepare documents having images in the backgrounds thereof, such as photos, graphics, pattern brushes, and text. Here, the application program 412 denotes a program for preparing such documents, such as PowerPoint, Word, Excel, or the like. The prepared documents can be stored in the memory unit 410.

The driver 414 generates color data, such as RGB, cyan, magenta, yellow, black, light cyan, light magenta, light yellow, and grayscale data, from the documents prepared using the application program 412. The generated color data relates to the images of the documents.

The half-tone screen table 416 includes angles for processing the color data. For example, the half-tone screen table 416 includes angles, such as a vertical angle, a horizontal angle, and a 45° angle.

The display unit 420 displays one or more user interfaces, which are used to set values for a number of vertical lines per inch of an image and/or an expansion ratio of a pattern. The user interfaces can be those illustrated in FIG. 2-3B. Accordingly, values for the number of vertical lines per inch of an image and/or the expansion ratio of a pattern brush are set, via the user interfaces of FIGS. 3A-3B, and according to options selected in FIG. 2. When the option 200 is selected from the user interface of FIG. 2, the user interface of FIG. 3A is displayed. When the option 210 is selected from the user interface of FIG. 2, the user interface of FIG. 3B is displayed. The user interfaces of FIGS. 2-3A can be referred to as a single user interface, as the user interfaces of FIGS. 3A and 3B can be modified versions of the user interface of FIG. 2.

The number of vertical lines per inch is set in the user interface of FIG. 3A, by selecting a preset value, such as the default value, the maximum value, or the average value, or can be entered by a user into the user setting field. Accordingly, the resolution of images of the document can be optimized for presentation, by setting the number of vertical lines per inch.

When the option 210 is selected from the user interface of FIG. 2, the user interface of FIG. 3B is displayed. From the user interface of FIG. 3B, preset values for the pattern brush, such as the default value, the [16*16] pixel, the [32*32] pixel, the [64*64] pixel may be selected, or value for the pattern brush may be input into the user setting field, by a user. The pattern brush values correspond to ratios at which the size of the pattern brush of a document is adjusted. Accordingly, increasing the pattern brush value increases the size of the pattern brush, when the document is converted to printing data. Thus, the quality of the printing data can be enhanced. The user interfaces of FIG. 2-3B can be displayed by the data processing apparatus 400 and/or by the image forming apparatus 450.

The data processing unit 430 converts the document into printing data. In detail, the data processing unit 430 includes a half-tone processing unit 432 and an image processing unit 434. The half-tone processing unit 432 adjusts the color data of the document, using the half-tone screen table 416, and in accordance with the set number of vertical lines per inch. The adjusted color data is included as a component of the printing data.

The image processing unit 434 adjusts the size of the pattern brush of the document, according to the expansion value set via the user interface of FIG. 3B. The size-adjusted pattern brush is included as a component of the printing data. If the size of a pattern brush increases, the number of pixels forming the pattern brush increases, and the quality of the corresponding printing data increases.

The data processing unit outputs the printing data to the interface. The printing data is transferred to the image forming apparatus 450, via the interface 440. The image forming apparatus 450 receives the printing data, via an interface 452, and stores the received printing data in a storage unit 458. The printing data may be transmitted in a compressed form, and may be decompressed by a data processing unit 454, prior to storage in the storage unit 458. An image forming unit 456 prints the printing data on a printing medium and/or displays the printing data as a presentation.

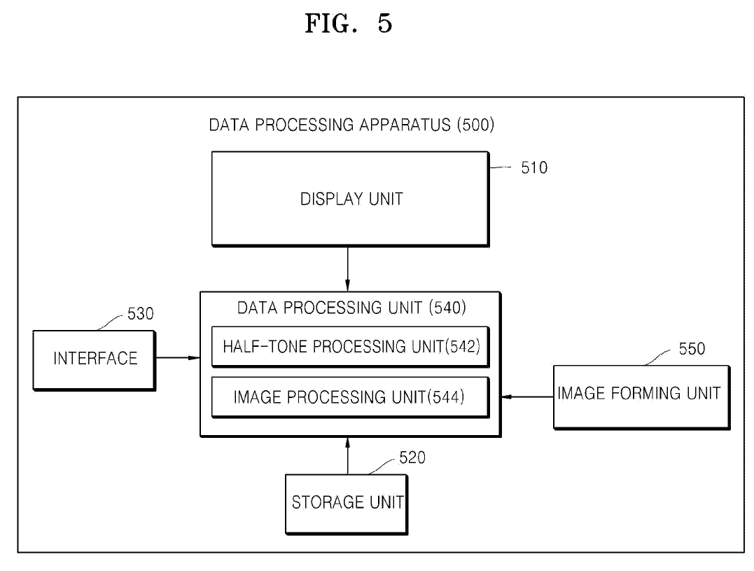

FIG. 5 is a block diagram illustrating a printing data processing apparatus 500, according to another exemplary embodiment of the present general inventive concept. The apparatus 500 includes a display unit 510, a storage unit 520, an interface 530, a data processing unit 540, and an image forming unit 550.

The display unit 510 displays the user interfaces of FIGS. 2-3B. Accordingly, the number of vertical lines per inch value and/or the pattern expansion value may be set, via the user interfaces of FIGS. 2-3B. When the option 200 is selected from the user interface of FIG. 2, the user interface of FIG. 3A is displayed, and when the option 210 is selected, the user interface of FIG. 3B is displayed. The operations of the user interfaces of FIGS. 2-3B is as previously described, and as such, will not be described again, in detail.

The storage unit 520 stores a document, and the stored document is transmitted to the data processing unit 540, via the interface 530. The interface 530 can connect the data processing apparatus 500 to an external device. For example, the interface 530 may connect the data processing apparatus 500 to a host having the document stored therein. Alternatively, the interface 530 may connect the data processing apparatus 500 to an external storage device, such as a universal serial bus (USB) memory stick, a digital camera, a memory card, or the like, which includes the document stored therein.

The document stored in the storage unit 520, or received via the interface 530, can include a data file and/or a figure file. The data processing unit 540 converts the document into printing data. In detail, the data processing unit 540 includes a half-tone processing unit 542 and an image processing unit 544.

The half-tone processing unit 542 adjusts the number of lines per inch of images included in the document, according to the values set via the user interface of FIG. 3A and a half-tone screen table. The image processing unit 544 adjusts the size of the pattern brushes of the document, according to the values set via the user interface of FIG. 3B. The data processing unit 540 outputs the printing data to the image forming unit 550, which prints the printing data on a printing medium and/or displays the printing data as a presentation.

The exemplary embodiments of the present general inventive concept can be written as computer programs and can be implemented in general-use digital computers that execute the programs using a computer readable recording medium. Also, the structures of data used in the exemplary embodiments of the present general inventive concept can be recorded on a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A document processing method comprising:
displaying a user interface;
using the user interface to set at least one of a number of vertical lines per inch value for the document and a pattern expansion value for the document, using the user interface; and
converting the document into printing data, by applying the set values.

2. The method of claim 1, wherein the user interface is driven by a driver of an image forming apparatus a display panel of the image forming apparatus, or a host of the image forming apparatus.

3. The method of claim 1, wherein the displaying of the user interface comprises displaying a user input value field and preset values, to set at least one of the vertical lines per inch value and the pattern expansion value.

4. The method of claim 1, wherein the converting of the document comprises half-tone processing the document, according to the vertical lines per inch value set via the user interface.

5. The method of claim 1, wherein the converting of the document comprises adjusting the size of a brush pattern of the document, according to the pattern expansion value set via the user interface.

6. The method of claim 1, further comprising forming an image on a printing medium, according to the printing data.

7. The method of claim 1, further comprising:
transferring the printing data from a document processing apparatus to an image forming apparatus; and
forming an image on a printing medium using the image forming apparatus, according to the printing data, when the user interface is driven by the driver of the image forming apparatus.

8. The method of claim 1, further comprising displaying printing data as a presentation.

9. A document processing apparatus comprising:
a display unit that displays a user interface to set at least one of a vertical lines per inch value for a document and a pattern expansion value for the document; and
a data processing unit that converts the document into printing data, according to the values set via the user interface.

10. The document processing apparatus of claim 9, wherein the user interface displays preset values and a field for user-input values, to set at least one of the number of vertical lines per inch value and the pattern expansion value.

11. The document processing apparatus of claim 9, wherein the data processing unit comprises: a half-tone processing unit that adjusts the number of vertical lines per inch of the document, according to the number of vertical lines per inch value set via the user interface.

12. The document processing apparatus of claim 9, wherein the data processing unit comprises an image processing unit that adjusts the size of a pattern brush of the document, according to the pattern expansion value set via the user interface.

13. The document processing apparatus of claim 9, further comprising an interface to connect the document processing apparatus to an image forming apparatus, through which the printing data is transferred.

14. A document processing apparatus comprising:
a display unit that displays a user interface to set at least one of a number of vertical lines per inch value of a document and a brush pattern expansion value of the document;
a data processing unit that converts the document into printing data, according to the values set via the user interface; and
an image forming unit that forms an image on a printing medium, according to the printing data, or displays the printing data as a presentation.

15. The document processing apparatus of claim 14, further comprising a storage unit to store the document.

16. The document processing apparatus of claim 14, further comprising an interface to connect the apparatus to a storage unit to store the document.

17. A document processing system comprising:
a host comprising,
a display unit that displays a user interface to set at least one of a number of vertical lines per inch value of a document and a pattern expansion value of the document,
a data processing unit that converts the document into printing data, according to the values set via the user interface, and
a first interface to output the printing data; and
an image forming apparatus comprising,
a second interface that receives the output printing data from the first interface, and
an image forming unit that forms an image on a printing medium, according to the received printing data, or displays the printing data as a presentation.

18. The document processing system of claim 17, wherein the host further comprises a memory to store an application program to produce the document, a driver to drive the user interface, and a half-tone screen table.

19. The document processing system of claim 17, wherein the image forming apparatus further comprises an image forming unit to display the printing data as the presentation.
